(19) United States
(12) Patent Application Publication
(10) Pub. No.: US 2009/0141506 A1
(43) Pub. Date: Jun. 4, 2009

(54) Illumination Device for Kitchen Hood

(76) Inventors: Shih-Chi Lan, Taichung City (TW); Yueh-Li Chien, Taipei County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/949,185

(22) Filed: Dec. 3, 2007

(51) Int. Cl. F21V 7/00; B60Q 1/00

(52) U.S. Cl. 362/351; 362/368

(57) ABSTRACT

An illumination device for a kitchen hood includes a light case made by high heat conductive material and a circuit board is connected to an inside of the light case. A terminal is connected to the circuit board and located outside of the light case. A light unit is connected to the circuit board and located in the light case. The light unit directly contacts the inside of the light case so as to conduct the heat from the light unit to the light case. The light case includes an open bottom with which a cover is engaged and a bulb shade is located between the light unit and the cover so as to focus or guide the light beam from the light unit.

### BACKGROUND OF THE INVENTION

(1) Field of the Invention

The present invention relates to an illumination device for a kitchen hood and uses high efficiency light emitting diodes whose heat dispensing areas contact the light case which is made by highly heat conductive material.

(2) Description of the Prior Art

A conventional illumination device for kitchen hood generally uses tin-filament light bulbs which are enclosed by light cases so as to prevent grease from attaching the light bulbs. The conventional tin-filament light bulbs require a lot of energy and generate high heat which makes the light cases to be blurred. The illumination feature is not satisfied by most users. Besides, the conventional illumination device occupies a lot of space which makes the conventional hood to be bulky and ugly. Some hook manufacturers use halogen light bulbs to provide higher illumination.

It is experienced that the halogen light bulbs generate even higher temperature which might be hurt the users and shortens the life of the halogen light bulbs. Light emitting diodes are better choices for the illumination device for kitchen hood. Nevertheless, the individual conventional light emitting diode cannot provide sufficient illumination so that multiple light emitting diodes have to be arranged together. Furthermore, the light beam is narrow and can only illuminate a small area.

The following Chart 1 is features of the conventional light emitting diodes.

CHART 1
features of conventional light emitting diodes.

| Parameter | Symbol | Rating | Unit |
|---|---|---|---|
| Continuous Forward Current | IF | 25 | [symbol] |
| Peak Forward | IFP | 100 | [symbol] |
| Current(Duty/10@1 KHZ) | | | |
| Reverse Voltage | VR | 5 | [symbol] |
| Operating Temperature | Topr | −40□~+85□ | □ |
| Storage Temperature | Tstg | −40□~+100□ | □ |
| Soldering Temperature | Tsol | 260 ± 5 | □ |
| Power Dissipation | Pd | 100 | [symbol] |
| Zener Reverse Current | Iz | 100 | [symbol] |
| Electiostatic Discharge | ESD | 4K | [symbol] |

The storage temperature of the conventional light emitting diodes is about 100□ and the operation temperature is about 85□, the current required is about 25 mA. The operation temperature does not burn the light emitting diodes and the problem for the conventional light emitting diodes is the less illumination.

The present invention intends to provide an illumination device for a kitchen hood and includes a high efficiency light emitting diode which includes a heat dispensing surface that is directly in contact with the light case which is made by high heat conductive material so that the heat can easily escape from the light emitting diode.

### SUMMARY OF THE INVENTION

The present invention relates to an illumination device for a kitchen hood and the illumination device comprises a light case and a circuit board is connected to an inside of the light case. A terminal is connected to the circuit board and located outside of the light case. A light unit is connected to the circuit board and located in the light case. The light case includes an open bottom with which a cover is engaged. The light unit directly contacts the inside of the light case which is made by high heat conductive material, so that heat from the light unit escapes via the light case.

The primary object of the present invention is to provide an illumination device for a kitchen hood and the heat from the light unit is directly conducted to the light case and the hood so that the heat can easily escape from the light unit. The light unit is further cooperated with a bulb shade which includes a refraction portion, a reflection portion so as to provide optimal illumination feature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the illumination device of the present invention;

FIG. 2 is a cross sectional view to show the illumination device of the present invention;

FIG. 3 is a cross sectional view to show the illumination device of the present invention, wherein the light beams penetrate through the illumination portion of the bulb shade;

FIG. 4 shows the bulb shade of the illumination device of the present invention;

FIG. 5 shows another embodiment of the bulb shade of the illumination device of the present invention;

FIG. 6 shows yet another embodiment of the bulb shade of the illumination device of the present invention;

FIG. 7 shows the underside of the light unit of the illumination device of the present invention, and

FIG. 8 shows the side view of the light unit of the illumination device of the present invention.

### DETAILED DESCRIPTION OF THE PREFERRED EMBODIMENTS

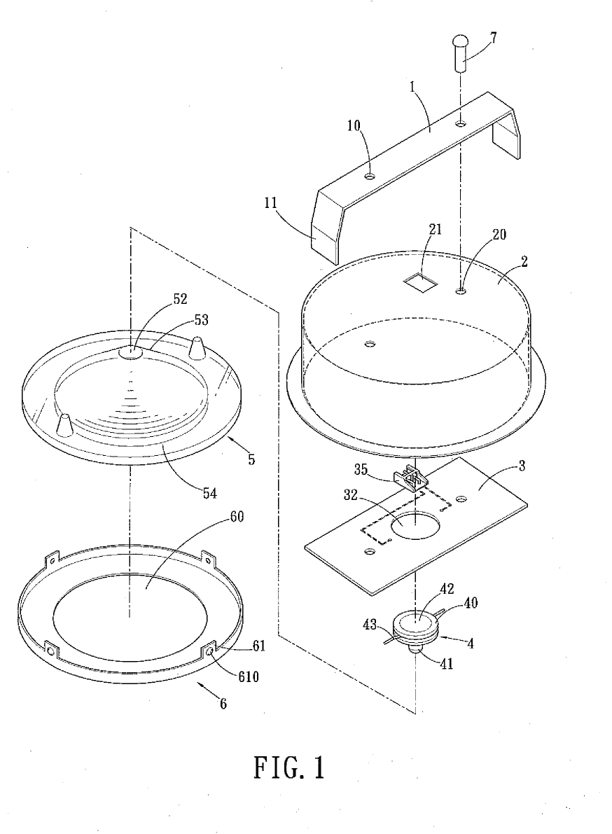

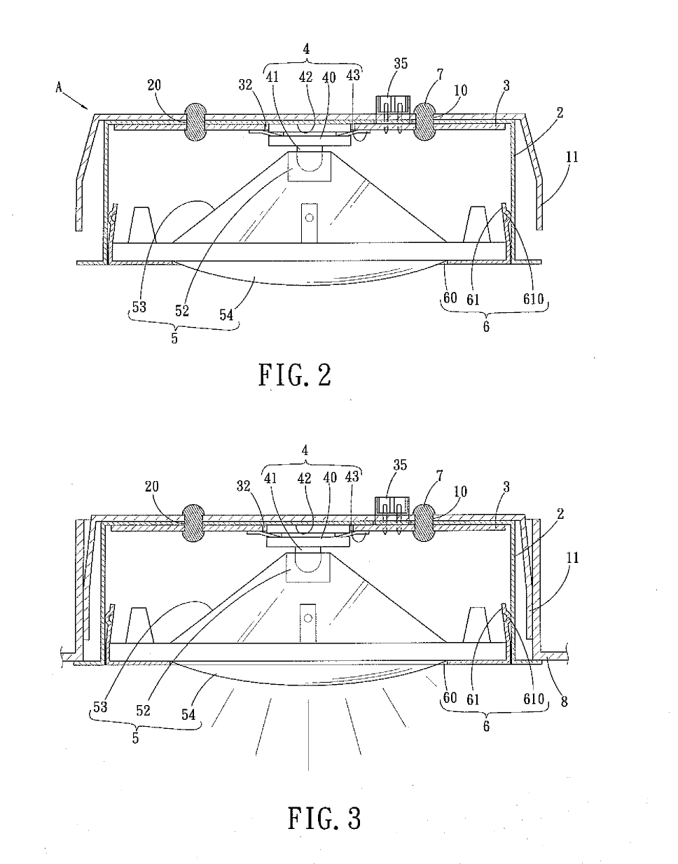

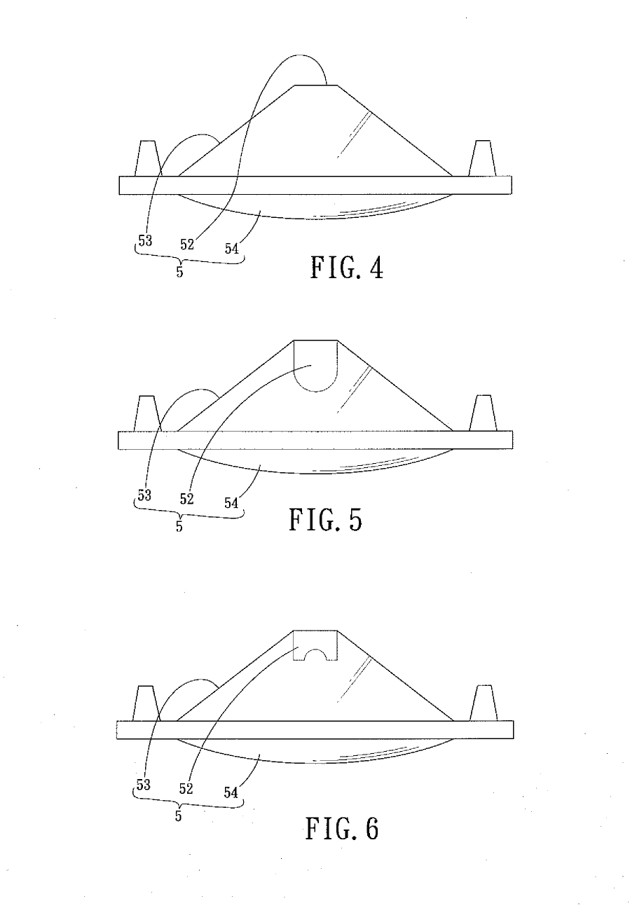

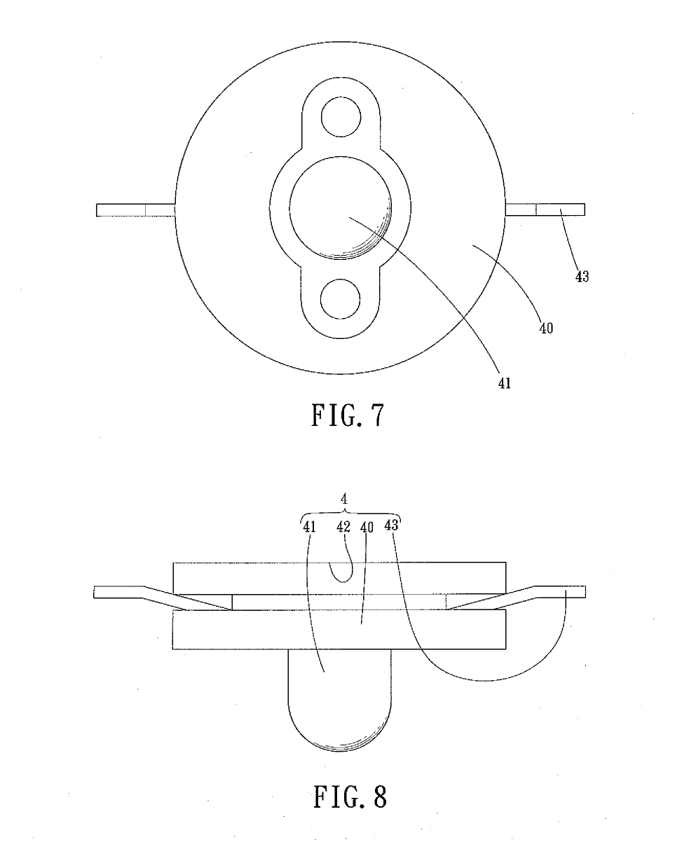

Referring to FIGS. 1 to 8, the illumination device “A” for a kitchen hood 8 of the present invention comprises a flexible plate 1 which is mounted onto a light case 2 and a circuit board 3 is connected to an inside of the light case 2. The light case 2 is made by high heat conductive material so as to quickly transfer heat away. The light case 2 includes an open bottom with which a cover 6 is engaged. The cover 6 is a loop-like member and includes an opening 60 and four lugs 61 extend perpendicularly from a periphery of the cover 6. Each lug 61 includes a protrusion 610 and is flexible so that the lugs 61 can be inserted to the inner periphery of the light case 2 and the protrusions 610 enhance the connection between the lugs 61 and the light case 2.

A terminal 35 is connected to the circuit board 3 and extends through a through hole 21 defined through a top of the light case 2 so that the terminal 35 is located outside of the light case 2. A light unit 4 is connected to the circuit board 3 and located in the light case 2. The flexible plate 1 includes two bent clip ends 11 and two first holes 10 are defined through the flexible plate 1. The light case 2 includes two second holes 20 so that two connection members 7 extend through the first holes 10, the second holes 20 and connect the circuit board 3.

The light unit 4 includes a bulb 41, a base 40, a heat dispensing surface 42 and legs 43. The bulb 41 and the heat dispensing surface 42 are located on opposite sides of the base 40, and the legs 43 extend from the base 40 radially so as to be connected with the circuit board 3 by tin or printed isolation material. The heat dispensing surface 42 of the light unit 4 extends through a positioning hole 32 defined through the circuit board 3 and directly contacts the inside of the light case 2 which is made by high heat conductive material, so that heat from the light unit 4 escapes via the light case 2 and the hood 8. By this way, the heat can be quickly escapade to the air and does not affect the term of life of the light unit 4. The heat dispensing surface 42 of the light unit 4 is a flat surface and the inside of the light case 2 is a flat surface, or the heat dispensing surface 42 of the light unit 4 is a convex surface and the inside of the light case 2 is a convex surface.

A bulb shade 5 is connected with the cover 6 and located between the cover 6 and the light unit 4. The bulb shade 5 includes a refraction portion 52, a reflection portion 53 and an illumination portion 54. The refraction portion 52 is located at an upper portion of the bulb shade 5 and made by transparent material so that light generated from the light unit 4 penetrates and refracts through the refraction portion 52. The reflection portion 53 is inclinedly located around the refraction portion 52 and made by transparent material or reflective material so that light can penetrate through or reflect from the reflection portion 53. The illumination portion 54 is located beneath a lower portion of the bulb shade 5 and made by transparent material or translucent material so as to focus or enlarge light beam from the light unit 4. The illumination portion 54 is engaged with the opening 60 of the cover 6

The bulb shade 5 is a solid member or a hollow member and the refraction portion 52 can be a flat surface, a recess, a hollow U-shaped recess or a U-shaped convex portion.

The following Chart 2 and Chart 3 show the features of the high efficiency light emitting diode which is used as the light bulb 41 of the light unit 4.

CHART 2
features for high efficiency light emitting diode.

| Parameter | Symbol | Rating | Unit |
|---|---|---|---|
| Operating Temperature | Topr | −40 [symbol] ~+100 [symbol] | [symbol] |
| Storage Temperature | Tstg | −40 [symbol] ~+100 [symbol] | [symbol] |
| Junction Temperature | Tj | 125 | [symbol] |
| Forward Current | IF | 1200 | m [symbol] |
| Power Dissipation | Pd | 5.0 | m [symbol] |
| Junction to heat-sink thermal | Pth | 16 | [symbol] / [symbol] |
| resistance | | | |

CHART 3
features for high efficiency light emitting diode.

| | | Sym- | | | | | |
|---|---|---|---|---|---|---|---|
| Parameter | Color | bol | Min. | Type | Max. | Unit | Condition |
| Luminous | [symbol] | φy | — | 18 | — | lm | LF [symbol] 350 mA |
| Flux | [symbol] | | — | 30 | — | | |
| | [symbol] | | — | 9 | — | | |
| | [symbol] | | — | 35 | — | | |
| View | — | 2θ1/2 | — | 120 | — | de- | |
| Angle | | | | | | gree | |
| Forward | [symbol] | [symbol] F | — | 2.2 | — | [symbol] | |
| Voltage | [symbol] | | — | 3.1 | — | | |
| | [symbol] | | — | 3.2 | — | | |
| | [symbol] | | — | 3.2 | — | | |
| Chroma- | [symbol] | x | — | 0.33 | — | — | |
| ticity | | y | — | 0.34 | — | | |
| coor- | | | | | | | |
| dinates | | | | | | | |

The storage temperature of the high efficiency light emitting diode is about 100□ and the operation temperature is about 100□, the current required is about 25 mA. The high temperature might burn the high efficiency light emitting diode, so that the optimized heat dispensing feature allows the high efficiency light emitting diode to be used for a longer life.

The different shapes of the refraction portion 52 can be a flat surface, a recess with a flat inner end, a hollow U-shaped recess or a U-shaped convex portion. The flat surface and the recess with a flat inner end can directly refract the light beam from the flat surface, and the hollow U-shaped recess performs as a concave lens which makes the light beam to be enlarged to illuminate a larger area. The U-shaped convex portion performs as a partial convex lens and partial concave lens. The different shapes of the refraction portion 52 provide different types of illumination features.

While we have shown and described the embodiment in accordance with the present invention, it should be clear to those skilled in the art that further embodiments may be made without departing from the scope of the present invention.

1. An illumination device for a kitchen hood, comprising:
a light case and a circuit board connected to an inside of the light case, a terminal connected to the circuit board and located outside of the light case, a light unit connected to die circuit board and located in the light case, the light case including an open bottom with which a cover is engaged, the light unit including a heat dispensing surface which directly contacts the inside of the light case which is made by high heat conductive material, so that heat from the light unit escapes via the light case, and
a flexible plate mounted to the outside of the light case and including two bent clip ends, two first holes defined through the flexible plate and connection members extending through the first holes to be connected to the circuit board.

2. (canceled)

3. The device as claimed in claim 1, wherein a bulb shade is connected with the cover and located between the cover and the light unit.

4. The device as claimed in claim 3, wherein the cover includes an opening and the bulb shade includes an illumination portion which is engaged with the opening.

5. The device as claimed in claim 4, wherein the bulb shade includes a refraction portion, a reflection portion and the illumination portion, the refraction portion is located at an upper portion of the bulb shade and made by transparent material so tat light generated from the light unit penetrates through the refraction portion, the reflection portion is inclinedly located round the refraction portion and made by reflective material, the illumination portion is located at lower portion of the bulb shade and made by transparent material.

6. (canceled)

7. (canceled)

8. The device as claimed in claim 3, wherein the light unit includes a bulb, a base, the heat dispensing surface and legs, the bulb and the heat dispensing surface are located on opposite sides of the base, the legs extend from the base radially.

9. (canceled)

10. The device as claimed in claim 8, wherein the heat dispensing surface of the light unit extends through a positioning hole defined through the circuit board and directly contacts the inside of the light case.

11. (canceled)

12. An illumination device for a kitchen hood comprising:
a light case and a circuit board connected to an inside of the light case, a terminal connected to the circuit board and located outside of the light case, a light unit connected to the circuit board and located in the light case, the light case including an open bottom with which a cover is engaged, the light unit including a bulb, a base, a heat dispensing surface and legs, the bulb and the heat dispensing surface are located on opposite sides of the base, the legs extend from the base radially, the heat dispensing surface of the light unit extends through a positioning hole defined through the circuit board and directly contacts the inside of the light case which is made by high heat conductive material, so that heat from the light unit escapes via the light case, and
a bulb shade connected with the cover and located between the cover and light unit.

13. The device as claimed in claim 12, wherein a flexible plate is mounted to the outside of the light case and includes two bent clip ends, two first holes are defined through the flexible plate and connection members extend through the first holes to be connected to the circuit board.
